(19) United States
(12) Patent Application Publication
(10) Pub. No.: US 2015/0232653 A1
(43) Pub. Date: Aug. 20, 2015

(54) HEAT-RESISTANT FLAME-RETARDANT RUBBER COMPOSITION, INSULATED WIRE AND RUBBER TUBE

(71) Applicant: SUMITOMO ELECTRIC INDUSTRIES, LTD., Osaka (JP)

(72) Inventors: Taro Fujita, Osaka-shi (JP); Hiroshi Hayami, Osaka-shi (JP); Shinya Nishikawa, Osaka-shi (JP); Yuji Ochi, Kanuma-shi (JP); Masahiro Tozawa, Kanuma-shi (JP)

(73) Assignee: SUMITOMO ELECTRIC INDUSTRIES, LTD., Osaka-shi, Osaka (JP)

(21) Appl. No.: 14/428,468

(22) PCT Filed: Sep. 19, 2013
(86) PCT No.: PCT/JP2013/075308

§ 371 Date: Mar. 16, 2015

(30) Foreign Application Priority Data
Jan. 17, 2013 (JP) 2013-006412

(51) Int. Cl. C08L 27/16; C09D 127/16

(52) U.S. Cl. CPC C08L 27/16; C09D 127/16

(57) ABSTRACT

The invention offers a heat-resistant flame-retardant rubber composition having low adhesiveness even in an uncrosslinked state, an insulated wire having an insulating covering composed of the heat-resistant flame-retardant rubber composition, and a rubber tube composed of the foregoing heat-resistant flame-retardant rubber composition. The heat-resistant flame-retardant rubber composition is formed by mixing 10 to 100 mass parts of an inorganic filler with 100 mass parts of a mixture produced by mixing (A) a vinylidene fluoride-hexafluoropropylene-based copolymer rubber and/or a vinylidene fluoride-hexafluoropropylene-tetrafluoroethylene-based copolymer rubber and (B) polyvinylidene fluoride at a mass ratio of 90:10 to 60:40. The insulated wire has an insulating covering composed of the rubber composition and irradiated with ionizing radiation. The rubber tube is composed of the foregoing heat-resistant flame-retardant rubber composition and irradiated with ionizing radiation.

### TECHNICAL FIELD

The present invention relates to a heat-resistant flame-retardant rubber composition that can form an insulating covering and the like having highly balanced excellent mechanical strength, high abrasion resistance, high heat resistance, high flame retardancy, high oil resistance, high insulating properties, high flexibility, and low-temperature properties; that has low adhesiveness; and that, therefore, is less likely to develop blocking when pelletized. The present invention relates to an insulated wire that has an insulating covering composed of the above-described heat-resistant flame-retardant rubber composition and that is advantageously used as an electric wire to be wired in a hardware giving a high-temperature environment, such as a harness in an engine room or an automatic transmission of a car. The present invention relates to a rubber tube formed of the above-described heat-resistant flame-retardant rubber composition.

### BACKGROUND ART

Electric wires such as a harness in an engine room or an automatic transmission of a car are exposed in a high-temperature environment. Consequently, the rubber composition, which is a material forming the insulating covering of these insulated wires, is required to have high heat resistance and high flame retardancy. On the other hand, the insulated wires in a car are sometimes exposed in a low-temperature environment. Consequently, the rubber composition is also required to have excellent low-temperature properties that prevent insulation breakdown from occurring even in a low-temperature environment. In addition, the insulating covering is also required to have high mechanical strength, including excellent tensile properties and the like, and high abrasion resistance such that even when the insulated wires repeatedly rub against each other or against the surrounding hardware owing to the vibration while the car runs, the insulating covering is less likely to wear. Furthermore, the insulating covering is also required to have flexibility because the wiring is performed by workers when the car is assembled and hard electric wires are difficult to bend, rendering the wiring operation difficult. The engine room and automatic transmission of a car have an inside environment where insulated wires are easily brought into contact with oil. Consequently, the insulated wire to be wired there is also required to have high oil resistance. It is also desired that the insulated wire be low in cost. In summary, the industry requires a heat-resistant flame-retardant rubber composition that has highly balanced excellent mechanical strength, high heat resistance, high flame retardancy, high oil resistance, high insulating properties, high flexibility, and low-temperature properties and that can be produced at low cost.

As for a material for an insulating covering that is highly flexible and that has excellent insulating properties, heat resistance, and oil resistance, a fluororubber (a fluorine-based elastomer) is known. However, a fluororubber is generally high-priced and is low in mechanical strength such as cut-through properties. In addition, in a state where the fluororubber is not crosslinked (an uncrosslinked state) immediately after the insulating covering is extruded, it has low shape recovery properties. Consequently, the insulating covering deforms easily under a load and even when the load is removed, the insulating covering does not return to the original shape, thereby posing a problem in that the insulated wire cannot be taken up to a reel. In addition, the electric wires are likely to adhere and stick to each other. This poses another problem. Furthermore, when a fluororubber is pelletized, it tends to develop blocking owing to its adhesiveness. As a result, it is difficult to use a plastic extruder, which accepts only pelletized material. It is necessary to provide an extruder equipped with a feeder capable of feeding a sheet-shaped material and an expensive dedicated rubber-extruding line capable of heat-crosslinking the extruded insulated wire with a tandem configuration. This system requires an enormous equipment cost. The line speed is limited because the heat crosslinking requires a certain period of time; this speed limitation becomes a factor of cost increase.

As for an insulating material having excellent heat resistance, a silicone rubber is also known. However, a silicone rubber is particularly low in cut-through properties. In addition, a silicone rubber also has a problem in that in an uncrosslinked state immediately after the extrusion, it deforms easily under a load and does not return to the original shape because of its low shape recovery properties. Consequently, as with the above-described fluorine-based elastomer, an expensive dedicated rubber-extruding line is necessary.

To solve the problem of mutual adherence and sticking of electric wires in an uncross-linked state of the employed rubber composition composed of a fluororubber, Patent Literature 1 has proposed a fluororubber composition that is composed of (A) a fluororubber such as a vinylidene fluoride-hexafluoropropylene-based copolymer rubber and (B) polyvinylidene fluoride or its copolymer and that has a (A)-(B) composition ratio falling within a specified range. Patent Literature 2 has also proposed a fluororubber composition produced by further mixing, with the fluororubber composition proposed by Patent Literature 1, (C) a silicone powder consisting mainly of polydimethylsiloxane at an amount falling within a specified range.

### CITATION LIST

Patent Literature

Patent Literature 1: the published Japanese patent application Tokukaihei 2-189354

Patent Literature 2: the published Japanese patent 2782880

### SUMMARY OF INVENTION

### Technical Problem

Despite the above description, although the fluororubber compositions proposed by Patent Literatures 1 and 2 have improved adhesiveness in an uncrosslinked state, the improvement is not sufficient yet. In the summer season, pellets in an uncrosslinked state sometimes develop blocking during storage. Consequently, the industry has been desiring a rubber composition in which the shortcoming in adhesiveness is further improved.

An object of the present invention is to offer a rubber composition that is a fluororesin-based heat-resistant flame-retardant rubber composition capable of being used as a material to form the covering of an insulated wire and that has further improved adhesiveness in an uncrosslinked state to such an extent that blocking of pellets and the like are less likely to develop.

Another object of the present invention is to offer an insulated wire having an insulating covering that is composed of the above-described fluororesin-based rubber composition, which is a heat-resistant flame-retardant rubber composition improved in adhesiveness; that has highly balanced excellent mechanical strength, high heat resistance, high flame retardancy, high oil resistance, high insulating properties, and low-temperature properties; and that can be produced at low cost. Yet another object is to offer a rubber tube that is composed of the foregoing heat-resistant flame-retardant rubber composition and that has the above-described excellent properties.

### Solution to Problem

The present inventor has studied intensely to solve the above-described problems and has found that in a mixture produced by mixing inorganic fillers such as calcium carbonate and talc with a vinylidene fluoride copolymer rubber and polyvinylidene fluoride, by setting the mixing ratio and the like within a specified range, a heat-resistant flame-retardant rubber composition can be obtained in which adhesiveness (close adhesiveness) of pellets in an uncrosslinked state is improved. The present inventor has also found that by irradiating the foregoing heat-resistant flame-retardant rubber composition with ionizing radiation to crosslink the resin, an insulating covering and a rubber tube can be obtained that have highly balanced excellent mechanical strength, high abrasion resistance, high heat resistance, high flame retardancy, high oil resistance, high insulating properties, high flexibility, and low-temperature properties and that can be produced at low cost. Thus, the present invention is completed.

The present invention (a first invention of the present application) is a heat-resistant flame-retardant rubber composition that contains:
(a) a mixture produced by mixing (A) a vinylidene fluoride-hexafluoropropylene-based copolymer rubber and/or a vinylidene fluoride-hexafluoropropylene-tetrafluoroethylene-based copolymer rubber and (B) polyvinylidene fluoride at a mass ratio of 90:10 to 60:40; and
(b) an inorganic filler.
   In the rubber composition, 10 to 100 mass parts of the above-described inorganic filler is mixed with 100 mass parts of the above-described mixture.

The foregoing heat-resistant flame-retardant rubber composition is a rubber composition that can be used to produce an insulating covering and a rubber tube both having excellent heat resistance and flame retardancy. In addition, this rubber composition has low adhesiveness between resins even in an uncrosslinked state and has an excellent feature in that its pellets in an uncrosslinked state are less likely to develop blocking during storage even in the summer season.

The conventional rubber composition cannot be pelletized because of its shortcoming in adhesiveness. Consequently, when the rubber composition is extruded, it is necessary to use a rubber extruder equipped with a feeder capable of feeding a sheet-shaped material. On the other hand, as the rubber composition of the present invention is less likely to develop blocking even when pelletized, it can be fed into a plastic extruder in the shape of pellets. In addition, when an insulated wire using the foregoing rubber composition is produced, it is not necessary to perform heat crosslinking immediately after the extrusion because mutual sticking of insulated wires is less likely to develop. Therefore, it is not necessary to use a dedicated rubber-extruding line capable of performing heat crosslinking immediately after the extrusion with a tandem configuration. For example, the crosslinking may be conducted by electron beam irradiation after the insulated wire is taken up to a reel temporarily after the extrusion. As described above, as the line speed is not limited by heat crosslinking, the production can be performed at high speed and therefore the equipment cost and production cost can be reduced.

The (A) constituent is a vinylidene fluoride-hexafluoropropylene-based copolymer rubber or a vinylidene fluoride-hexafluoropropylene-tetrafluoroethylene-based copolymer rubber. The (A) constituent may also be a mixture of the foregoing two types of rubber. An (A) constituent containing at least 10 mass % hexafluoropropylene is desirably used. The vinylidene fluoride-hexafluoropropylene-based copolymer rubber forming the (A) constituent can be produced by emulsification- or suspension-polymerizing vinylidene fluoride and hexafluoropropylene with a radical initiator. The vinylidene fluoride-hexafluoropropylene-tetrafluoroethylene-based copolymer rubber can be produced by further adding tetrafluoroethylene to the above-described reaction system and by using a similar procedure. These rubbers are available in the market, so that commercially available materials may also be used as the (A) constituent.

The types of polyvinylidene fluoride for the (B) constituent include homopolymers of polyvinylidene fluoride. The foregoing types also include resins produced by copolymerizing other monomers with vinylidene fluoride within a range that does not impair the gist of the present invention. The types of other monomers to be copolymerized include hexafluoropropylene. In this case, the ratio of copolymerization is less than 10 mass %, desirably less than 5 mass %. The polyvinylidene fluoride homopolymer and the copolymer of vinylidene fluoride both capable of being used as the (B) constituent are also available in the market, so that commercially available materials may also be used.

The containing of the (A) constituent is necessary because when the heat-resistant flame-retardant rubber composition of the present invention is formed into the shape of a film such as an insulating covering and a tube, the (A) constituent gives to the film high heat resistance, high flame retardancy, high insulating properties, and excellent low-temperature properties. In addition, the containing of the (A) constituent can give to the film excellent flexibility.

The containing of the (B) constituent is necessary to improve the adhesion of the resin in an uncrosslinked sate (to decrease the adhesiveness). In addition, the containing is necessary because when the heat-resistant flame-retardant rubber composition of the present invention is formed into a film or the like, the (B) constituent gives to the film or the like high oil resistance and excellent tensile properties. Furthermore, the containing of the (B) constituent can give to the film or the like excellent abrasion resistance and high cut-through properties. In particular, by using, as the polyvinylidene fluoride for the (B) constituent, a polyvinylidene fluoride homopolymer having a melting point of 160° C. or higher, particularly high heat resistance and oil resistance can be achieved and the abrasion resistance and cut-through properties are also increased.

In the heat-resistant flame-retardant rubber composition of the present invention, the mass ratio of the above-described (A) constituent to (B) constituent is in a range of 90:10 to 60:40. When the mass ratio of the (A) constituent exceeds 90% of the total mass of the (A) constituent and the (B) constituent, that is, when the mass ratio of the (B) constituent is less than 10%, a rubber composition having sufficiently improved adhesiveness cannot be obtained. On the other hand, when the mass ratio of the (A) constituent is less than 60%, even when the rubber composition is crosslinked by irradiation with radiation, the obtained formed body (a film or the like) is inferior in flexibility and low-temperature properties.

The rubber composition of the present invention has a feature in that an inorganic filler is mixed. The mixing of an inorganic filler is necessary to improve the adhesion of the resin in an uncrosslinked state. The mixing can decrease the problem-creating adhesiveness, the problem including blocking of pellets. When the total amount of the (A) constituent and the (B) constituent is taken as 100 mass parts, the mixed amount of the inorganic filler falls within a range of 10 to 100 mass parts. When the mixed amount of the inorganic filler is less than 10 mass parts, a sufficient decrease in adhesiveness cannot be achieved. In contrast, when more than 100 mass parts, even when the resin is crosslinked by irradiation with radiation, the obtained formed body (a film or the like) is inferior in tensile properties such as tensile strength.

The types of inorganic filler include heavy and light calcium carbonates; talc (hydrated magnesium silicate); clay (aluminum silicate); zinc oxide; silica; carbon; metal hydroxide such as magnesium hydroxide, aluminum hydroxide, and calcium hydroxide; and materials produced by surface-treating the foregoing substances. These inorganic fillers may be used singly or in combination of at least two types.

The addition of an inorganic filler improves the heat resistance and flame retardancy and has an effect of decreasing the product price. More specifically, the mixing of the above-described (A) constituent, (B) constituent, and an inorganic filler at the above-described specific range not only prevents the adhesion of the rubber composition in an uncrosslinked state but also highly balances excellent mechanical strength, high abrasion resistance, high heat resistance, high flame retardancy, high oil resistance, high insulating properties, high flexibility, and low-temperature properties and enables the production of formed bodies such as an insulating covering and a rubber tube at a low cost.

To the heat-resistant flame-retardant rubber composition of the present invention, the following additives may be added, in addition to the above-described necessary constituents, in a range that does not impair the gist of the invention: a halogen-free flame retardant such as a phosphorus-based flame retardant; a bromine-based flame retardant; a chlorine-based flame retardant; antimony trioxide; antioxidants such as phenol-, amine-, sulfur-, and phosphorus-based antioxidants; lubricants such as stearic acid, fatty acid amide, silicone, polyethylene wax; a colored pigment; and the like. These additives may be added singly or in combination of at least two types.

A second invention of the present application is the heat-resistant flame-retardant rubber composition as stated in the first invention of the present application in which the inorganic filler is selected from calcium carbonate and talc. Among the above-described inorganic fillers, calcium carbonate, talc, or both are desirable in terms of heat resistance, mechanical properties, and cost. The types of calcium carbonate include a ground calcium carbonate that is produced by mechanically pulverizing a natural row material consisting mainly of CaCO₃ such as limestone and by performing classification and a precipitated calcium carbonate (a light calcium carbonate) that is chemically produced. In terms of cost, a ground calcium carbonate is desirable.

In addition to the above-described heat-resistant flame-retardant rubber composition, the present invention offers an insulated wire having an insulating covering composed of the foregoing heat-resistant flame-retardant rubber composition. More specifically, a third invention of the present application is an insulated wire having an insulating covering produced by applying onto a conductor the heat-resistant flame-retardant rubber composition stated in the first or second invention of the present application and then by performing irradiation with ionizing radiation.

The above-described insulated wire is an electric wire having an insulating covering that is formed of the heat-resistant flame-retardant rubber composition of the present invention, the composition having a resin crosslinked by irradiation with ionizing radiation. Consequently, the electric wire has highly balanced excellent mechanical strength, high abrasion resistance, high heat resistance, high flame retardancy, high oil resistance, high insulating properties, high flexibility, and low-temperature properties and is advantageously used, for example, in a high-temperature environment, to which a harness in an engine room or an automatic transmission of a car is exposed, for example. The term “an insulated wire” means not only a narrowly defined insulated wire composed of a conductor and an insulating covering but also an insulated cable formed by further covering one or two or more narrowly defined insulated wires with a protective covering.

The above-described insulated wire can be produced by forming an insulating covering that covers a conductor with the heat-resistant flame-retardant rubber composition of the present invention and by crosslinking the resin through irradiation with ionizing radiation. The process of covering can be performed by a method employed in the production of the conventional insulated wire, such as a method in which a rubber composition is extruded on the conductor. As for the conductor, a conductor such as copper wires or the like used in an insulated wire and an insulated cable both conventionally used for wiring in an apparatus and a car can be used.

The irradiation of a rubber composition with ionizing radiation improves the shape recovery properties, heat deformation properties, tensile properties, heat resistance, oil resistance, and cut-through properties. The types of ionizing radiation include y-rays, X-rays and other electromagnetic waves and particle beams. Among them, an electron beam is particularly desirable because it is widely used in industrial applications, is easy to control, and enables low-cost crosslinking. Electron-beam irradiation can be performed by using a well-known means of electron-beam irradiation conventionally used for crosslinking resins, for example, and be conducted through an established procedure. The amount of irradiation of ionizing radiation is selected such that the resin can achieve desired mechanical properties such as tensile properties, heat resistance, and so on by being crosslinked. In the case of electron-beam irradiation, usually, 30 to 500 kGy or so is desirable.

In addition to the above-described heat-resistant flame-retardant rubber composition and insulated wire, the present invention further offers a rubber tube produced by forming the foregoing rubber composition into the shape of a tube. More specifically, a fourth invention of the present application is a rubber tube produced by forming the heat-resistant flame-retardant rubber composition as stated in the first or second invention of the present application into the shape of a tube and then by performing irradiation with ionizing radiation.

Applications of the rubber tube of the present invention include a heat-shrinkable tube, which radially shrinks when heated at the melting point or higher of the rubber composition. The forming into the shape of a tube can be performed by a method employed in the production of the conventional resin tube. Similarly, the obtained tube can be modified into a heat-shrinkable tube by a method employed in the production of the conventional heat-shrinkable tube. The irradiation with ionizing radiation can be performed through a method similar to that employed in the case of the above-described insulated wire by using similar conditions and the like.

### Advantageous Effects of Invention

The heat-resistant flame-retardant rubber composition of the present invention has low adhesiveness in an uncrosslinked state and is less likely to create problems such as blocking of pellets. A formed body, such as an insulating covering of an insulated wire and a rubber tube, having highly balanced excellent mechanical strength, high abrasion resistance, high heat resistance, high flame retardancy, high oil resistance, high insulating properties, high flexibility, and low-temperature properties can be obtained at low cost by performing irradiation with ionizing radiation after the forming.

Consequently, the insulating covering of an insulated wire and the rubber tube both of the present invention have highly balanced mechanical strength, high abrasion resistance, high heat resistance, high flame retardancy, high oil resistance, high insulating properties, high flexibility, and low-temperature properties and can be produced at low cost. As a result, the insulated wire of the present invention is advantageously used as an electric wire to be used in a high-temperature environment, such as an electric wire wired in an engine room or an automatic transmission of a car.

### DESCRIPTION OF EMBODIMENTS

In the following, embodiments of the present invention are explained based on examples. The scope of the present invention is not limited to the examples and can be modified variously within the scope that does not impair the gist of the present invention.

### Examples

First, individual materials used in Examples and Comparative examples are shown below.
A vinylidene fluoride-hexafluoropropylene copolymer (shown as “binary FKM” in Tables): Viton A200 (made by DuPont Dow Elastomers Co.)
A vinylidene fluoride-hexafluoropropylene-tetrafluoroethylene copolymer (shown as “ternary FKM” in Tables): Viton B202 (made by DuPont Dow Elastomers Co.)
A vinylidene fluoride polymer (shown as “PVdF homopolymer” in Tables): KYNAR 720 (made by ARKEMA K. K.)
A vinylidene fluoride-hexafluoropropylene copolymer (shown as “PVdF copolymer” in Tables): KYNAR 2800 (made by ARKEMA K. K.; content of hexafluoropropylene: about 5 mass %)
Ground calcium carbonate: SOFTON 2200 (made by SHIRAISHI CALCIUM KAISHA, LTD.)
Talc: SIMGON TALC (made by NIPPON TALC CO., LTD.)
Clay: NN kaolin clay (made by TAKEHARA KAGAKU KOGYO CO., LTD.)

### Examples 1 to 7 and Comparative Examples 1 to 4

The constituents shown in Tables I and II (shown in mass part in the tables) were kneaded with an open roll and pelletized with a pelletizer. The pellet was subjected to the evaluation of its adhesiveness by the method described below. The obtained pellet was fed into an extruder for a covering of an electric wire and extruded on a conductor of 0.5 SQ (TA 19/0.19) (copper wire; conductor diameter: 0.95 mm) to form a covering having a thickness of 0.375 mm and to obtain an electric wire having an overall diameter of 1.7 mm.

Subsequently, irradiation was performed with an electron beam at 100 kGy by using an electron beam irradiation apparatus to produce an insulated wire insulation-covered with a crosslinked rubber composition. The insulated wire (or its insulating covering) obtained as described above underwent the evaluation of tensile properties (tensile strength and tensile elongation), flexibility, heat resistance, flame retardancy, insulating properties, oil resistance, and low-temperature properties through the methods described below. The results are shown in Tables I and II.

### Tensile Properties (Tensile Strength and Tensile Elongation):

The conductor was pulled out of the obtained insulated wire to obtain a tube formed of the insulating covering. On this sample, tensile strength and tensile elongation were measured in accordance with JIS C 3005 (1986).

### Flexibility:

Tensile elongation and tensile stress were measured in accordance with JIS C 3005 (1986). The value obtained by multiplying the tensile stress at a tensile elongation of 2% by 50 was defined as a secant modulus to use as an indicator of the flexibility. The secant modulus has a value close to the Young's modulus. The measured values of the scant modulus are shown in Tables I and II. The value of 100 MPa or less was judged to be satisfactory.

### Heat Resistance:

In accordance with ISO 6722 Specification, the obtained insulated wire was cut to a length of 350 mm, the insulating covering was removed from both end portions having a length of 25 mm, the insulated wire was left standing in a constant-temperature oven at 200° C. for 3,000 hours, and then the insulated wire was wound three times on a rod having a diameter of 2.55 mm, which is 1.5 times the outer diameter of the insulating covering. Subsequently, a voltage withstand test was carried out by applying a voltage of 1 kV onto the insulated wire for one minute to find out whether insulation breakdown occurs or not, and the condition of cracking in the insulating covering was observed. The results are shown in Tables I and II according to the following criteria:
Breakdown occurred: unsatisfactory; no breakdown occurred: satisfactory
Cracking was observed: unsatisfactory; no cracking was observed: satisfactory

### Flame Retardancy:

In accordance with ISO 6722 Specification, the insulated wire was cut to a length of 600 mm, both ends were fixed at an angle of 45 degrees, and the flame of a burner was posi- tioned so as to be perpendicular to the insulated wire. The flame was adjusted such that the outer flame had a length of 100 mm and the inner flame 50 mm and was positioned such that the tip of the inner flame was brought into contact with the insulated wire. The contact was continued until the conductor was exposed. However, when the conductor was not exposed even 15 seconds after the contact, the contact was terminated. When the burning went out within 70 seconds and the upward burnt length was 450 mm or less, the sample was judged to be satisfactory. If a sample exceeded these limits, it was judged to be unsatisfactory.

### Insulating Properties:

The insulated wire obtained as described above was immersed in hot water at 70° C. for two hours. Then, the volume resistivity (Ω·cm) of the insulating covering was measured with a volume resistivity-measuring device at DC 100 V or higher. The measured value is shown in Tables I and II.

### Oil Resistance:

In accordance with Method II of ISO 6722, the obtained insulated wire was immersed in commercially available engine oil at room temperature for 20 hours, and then the rate of variation in outer diameter was measured. Subsequently, a voltage withstand test was carried out in water by applying 1 kV for one minute. When the rate of variation in outer diameter was 15% or less and no insulation breakdown occurred, the sample was judged to be satisfactory and is so expressed in Tables I and II.

### Low-Temperature Properties:

In accordance with ISO 6722 Specification, the obtained insulated wire was left standing at −40° C. for four hours, and then the wire was wound on a rod having a diameter of 2.55 mm, which is 1.5 times the outer diameter of the insulating covering. Subsequently, a voltage withstand test was carried out by applying a voltage of 1 kV onto the insulated wire for one minute to find out whether insulation breakdown occurs or not, and the condition of cracking in the insulating covering was observed. The results are shown in Tables I and II according to the following criteria:
Breakdown occurred: unsatisfactory; no breakdown occurred: satisfactory
Cracking was observed: unsatisfactory; no cracking was observed: satisfactory

### Adhesiveness of Pellets:

The pellets obtained as described above were left standing at 40° C. for one day, and the presence or absence of adhesion between pellets was observed. The results are shown in Tables I and II according to the following criteria:
No sticking was observed or pellets were easily separated by hand: satisfactory
Sticking was observed and pellets were difficult to be separated by hand: unsatisfactory

TABLE I

| | | Example 1 | Example 2 | Example 3 | Example 4 | Example 5 | Example 6 |
|---|---|---|---|---|---|---|---|
| Binary FKM | | 90 | 90 | 60 | 60 | 60 | — |
| Ternary FKM | | — | — | — | — | — | 90 |
| PVdF homopolymer | | 10 | 10 | 40 | 40 | 40 | 10 |
| PVdF copolymer | | — | — | — | — | — | — |
| Heavy calcium | | 10 | 100 | 100 | — | — | 100 |
| carbonate | | | | | | | |
| Talc | | — | — | — | 100 | — | — |
| Clay | | — | — | — | — | 100 | — |
| Total | | 110 | 200 | 200 | 200 | 200 | 200 |
| Tensile | Tensile strength | 16.0 | 8.8 | 12.1 | 11.5 | 10.2 | 8.9 |
| properties | (MPa) | | | | | | |
| | Tensile | 310 | 210 | 160 | 170 | 160 | 210 |
| | elongation ( %) | | | | | | |
| Secant modulus (MPa) | | 31 | 62 | 95 | 92 | 85 | 58 |
| Heat | Insulation | Satisfactory | Satisfactory | Satisfactory | Satisfactory | Satisfactory | Satisfactory |
| resistance | breakdown | | | | | | |
| | Cracking | Satisfactory | Satisfactory | Satisfactory | Satisfactory | Satisfactory | Satisfactory |
| Flame resistance | | Satisfactory | Satisfactory | Satisfactory | Satisfactory | Satisfactory | Satisfactory |
| Insulating property | | 2.4 | 8.4 | 7.5 | 6.1 | 54 | 9.5 |
| (10¹² Ω · cm) | | | | | | | |
| Oil resistance | | Satisfactory | Satisfactory | Satisfactory | Satisfactory | Satisfactory | Satisfactory |
| Low- | Cracking | Satisfactory | Satisfactory | Satisfactory | Satisfactory | Satisfactory | Satisfactory |
| temperature | Insulation | Satisfactory | Satisfactory | Satisfactory | Satisfactory | Satisfactory | Satisfactory |
| properties | breakdown | | | | | | |

| | | | | | | |
|---|---|---|---|---|---|---|
| Adhesiveness of pellets | Satisfactory | Satisfactory | Satisfactory | Satisfactory | Satisfactory | Satisfactory |

TABLE II

| | | | Comparative | Comparative | Comparative | Comparative |
|---|---|---|---|---|---|---|
| | | Example 7 | Example 1 | Example 2 | Example 3 | Example 4 |
| Binary FKM | | 90 | 95 | 90 | 90 | 50 |
| Ternary FKM | | — | — | — | — | — |
| PVdF homopolymer | | — | 5 | 10 | 10 | 50 |
| PVdF copolymer | | 10 | — | — | — | — |
| Heavy calcium | | 100 | 10 | 5 | 120 | 100 |
| carbonate | | | | | | |
| Talc | | — | — | — | — | — |
| Clay | | — | — | — | — | — |
| Total | | 200 | 110 | 105 | 220 | 200 |
| Tensile | Tensile strength | 9.2 | 10.5 | 13.0 | 7.5 | 8.2 |
| properties | (MPa) | | | | | |
| | Tensile | 230 | 90 | 190 | 150 | 140 |
| | elongation (%) | | | | | |
| Secant modulus (MPa) | | 63 | 23 | 27 | 75 | 105 |
| Heat | Insulation | Satisfactory | Satisfactory | Satisfactory | Satisfactory | Satisfactory |
| resistance | breakdown | | | | | |
| | Cracking | Satisfactory | Satisfactory | Satisfactory | Satisfactory | Satisfactory |
| Flame resistance | | Satisfactory | Satisfactory | Satisfactory | Satisfactory | Satisfactory |
| Insulating property | | 9.2 | 1.1 | 0.92 | 6.8 | 2.4 |
| (10¹² Ω · cm) | | | | | | |
| Oil resistance | | Satisfactory | Satisfactory | Satisfactory | Satisfactory | Satisfactory |
| Low- | Insulation | Satisfactory | Satisfactory | Satisfactory | Satisfactory | Unsatisfactory |
| temperature | breakdown | | | | | |
| properties | Cracking | Satisfactory | Satisfactory | Satisfactory | Satisfactory | Unsatisfactory |

| | | | | | |
|---|---|---|---|---|---|
| Adhesiveness of pellets | Satisfactory | Unsatisfactory | Unsatisfactory | Satisfactory | Satisfactory |

Examples 1 to 7 are all evaluated as satisfactory in both cracking and insulation break- down in the items of heat resistance and low-temperature properties, so that they satisfy the specification on the insulating covering. They, also, are all evaluated as satisfactory in flame retardancy, oil resistance, and adhesiveness of pellets, so that they satisfy the specification. Furthermore, they all satisfy the specification of tensile properties (tensile strength: 7.8 MPa or more; tensile elongation: 150% or more) and the criterion of the insulating property (10⁹ Ω·cm or more). Consequently, these data show that they are excellent as a material for the insulating covering of an insulated wire such as a harness.

On the other hand, Comparative example 1, in which the mixed amount of the (A) constituent exceeds 90 mass % of the total amount of the (A) constituent and the (B) constituent, and Comparative example 2, in which the mixed amount of the inorganic filler (ground calcium carbonate) is less than 10 mass % of the total amount of the (A) constituent and the (B) constituent, are inferior in the adhesiveness of pellets. These data show that to sufficiently improve the adhesiveness of pellets, it is necessary for the mixed amount of the (A) constituent to be 90 mass % or less and for the mixed amount of the inorganic filler to be 10 mass % or more.

Comparative example 3, in which the mixed amount of the inorganic filler (ground calcium carbonate) exceeds 100 mass % of the total amount of the (A) constituent and the (B) constituent, and Comparative example 4, in which the mixed amount of the (A) constituent is less than 60 mass % of the total amount of the (A) constituent and the (B) constituent, cannot achieve sufficient tensile properties. These data show that to achieve sufficient tensile properties, it is necessary for the mixed amount of the (A) constituent to be 60 mass or more and for the mixed amount of the inorganic filler to be 100 mass % or less. Furthermore, Comparative example 4, in which the mixed amount of the (A) constituent is less than 60 mass % of the total amount of the (A) constituent and the (B) constituent, has a secant modulus exceeding 100 MPa and hence fails to meet the specification of the flexibility. Consequently, this data shows that to achieve a flexibility satisfying the specification, also, it is necessary for the mixed amount of the (A) constituent to be 60 mass % or more.

1. A heat-resistant flame-retardant rubber composition, comprising:
(a) a mixture produced by mixing (A) a vinylidene fluoride-hexafluoropropylene-based copolymer rubber and/or a vinylidene fluoride-hexafluoropropylene-tetrafluoroethylene-based copolymer rubber and (B) a polyvinylidene fluoride homopolymer having a melting point of 160° C. or higher at a mass ratio of 90:10 to 60:40; and
(b) an inorganic filler;
wherein 10 to 100 mass parts of the inorganic filler is mixed with 100 mass parts of the mixture; the heat-resistant flame-retardant rubber composition being to be used as an insulating covering for a harness in an engine room or an automatic transmission of a car.

2. The heat-resistant flame-retardant rubber composition as defined by claim 1, wherein the inorganic filler is selected from calcium carbonate and talc.

3. An insulated wire, comprising an insulating covering produced by applying onto a conductor the heat-resistant flame-retardant rubber composition as defined by claim 1 and then by performing irradiation with ionizing radiation;
the insulated wire being intended for a harness in an engine room or an automatic transmission of a car.

4. A rubber tube, produced by forming the heat-resistant flame-retardant rubber composition as defined by claim 1 into the shape of a tube and then by performing irradiation with ionizing radiation;
the rubber tube being to be used as an insulating covering for a harness in an engine room or an automatic transmission of a car.

5. An insulated wire, comprising an insulating covering produced by applying onto a conductor the heat-resistant flame-retardant rubber composition as defined by claim 2 and then by performing irradiation with ionizing radiation;
the insulated wire being intended for a harness in an engine room or an automatic transmission of a car.

6. A rubber tube, produced by forming the heat-resistant flame-retardant rubber composition as defined by claim 2 into the shape of a tube and then by performing irradiation with ionizing radiation;
the rubber tube being to be used as an insulating covering for a harness in an engine room or an automatic transmission of a car.
